(19) United States
(12) Patent Application Publication
(10) Pub. No.: US 2023/0141449 A1
(43) Pub. Date: May 11, 2023

(54) OPTICAL CONNECTION STRUCTURE, FERRULE, AND OPTICAL CONNECTOR

(71) Applicants: SUMITOMO ELECTRIC INDUSTRIES, LTD., Osaka-shi, Osaka (JP); NIPPON TSUSHIN DENZAI CO., LTD., Komaki-shi, Aichi (JP)

(72) Inventors: Sho YAKABE, Osaka-shi (JP); Motoyoshi KIMURA, Komaki-shi (JP)

(73) Assignees: SUMITOMO ELECTRIC INDUSTRIES, LTD., Osaka-shi, Osaka (JP); NIPPON TSUSHIN DENZAI CO., LTD., Komaki-shi, Aichi (JP)

(21) Appl. No.: 17/913,260

(22) PCT Filed: Feb. 17, 2021
(86) PCT No.: PCT/JP2021/005960

§ 371 Date: Sep. 21, 2022

(30) Foreign Application Priority Data
Mar. 27, 2020 (JP) 2020-058258

(51) Int. Cl. G02B 6/38

(52) U.S. Cl. CPC G02B 6/3885; G02B 6/3853; G02B 6/3874

(57) ABSTRACT

An optical connection structure includes a plurality of optical fibers, a ferrule, and an adapter. The ferrule has a first side surface and a second side surface facing each other. The first side surface is provided with a first recess portion or a first protrusion portion extending along a first direction in which the ferrule is inserted into the adapter. The second side surface is provided with a second recess portion or a second protrusion portion extending along the first direction. An inner surface of the adapter is provided with each of a third protrusion portion or a third recess portion fittable with the first recess portion or the first protrusion portion and a fourth protrusion portion or a fourth recess portion fittable with the second recess portion or the second protrusion portion.

### TECHNICAL FIELD

The present disclosure relates to an optical connection structure, a ferrule, and an optical connector.

This application is based upon and claims the benefit of priority from Japanese Patent Application No. 2020-058258 filed on Mar. 27, 2020, and the entire contents of which are incorporated herein by reference.

### BACKGROUND ART

Patent Literature 1 discloses a technique for aligning multi-core optical fibers with each other using a guide pin. In this technique, end portions of a pair of guide pins are respectively inserted into a pair of guide pin insertion holes provided in the tip surface of a ferrule, and the other end portions of the pair of guide pins are respectively inserted into a pair of guide pin insertion holes provided in the tip surface of a connection counterpart ferrule. As a result, the alignment of the multi-core optical fibers (that is, the alignment of the multi-core optical fiber and the multi-core optical fiber of the connection counterpart) is performed.

### Citation List

### Patent Literature

Patent Literature 1: Japanese Unexamined Patent Publication No. 2019-90974

### SUMMARY OF INVENTION

### Technical Problem

An optical connection structure according to one embodiment of the present disclosure includes: a plurality of optical fibers; a ferrule holding the plurality of optical fibers; and a tubular adapter where the ferrule is inserted and fitted such that the ferrule and another ferrule face each other in the tubular shape. The ferrule has a first side surface and a second side surface facing each other. The first side surface is provided with a first recess portion or a first protrusion portion extending along a first direction in which the ferrule is inserted into the adapter. The second side surface is provided with a second recess portion or a second protrusion portion extending along the first direction. An inner surface of the adapter is provided with a third protrusion portion or a third recess portion fittable with the first recess portion or the first protrusion portion and a fourth protrusion portion or a fourth recess portion fittable with the second recess portion or the second protrusion portion.

A ferrule according to one embodiment of the present disclosure includes: a plurality of optical fiber holding portions for respectively holding a plurality of optical fibers; and a first side surface and a second side surface facing each other. The first side surface is provided with a first recess portion or a first protrusion portion extending along a first direction in which the plurality of optical fiber holding portions extend. The second side surface is provided with a second recess portion or a second protrusion portion extending along the first direction.

An optical connector according to one embodiment of the present disclosure includes: the ferrule described above; and the plurality of optical fibers respectively held in the plurality of optical fiber holding portions.

### BRIEF DESCRIPTION OF DRAWINGS

FIG. 1A is a perspective view illustrating a state where an optical connector is attached to an adapter in an optical connection structure according to one embodiment.

FIG. 1B is a perspective view illustrating a state where the optical connector is removed from the adapter in the optical connection structure according to one embodiment.

FIG. 2 is a perspective view illustrating a ferrule according to one embodiment.

FIG. 3 is a front view illustrating the ferrule according to one embodiment.

FIG. 4 is a cross-sectional view of the ferrule along the IV-IV line of FIG. 3.

FIG. 5 is a cross-sectional view illustrating the adapter in a state where the ferrule is inserted and fitted.

FIG. 6 is a cross-sectional view illustrating an adapter in a state where a ferrule is inserted and fitted in an optical connection structure according to a first modification example.

FIG. 7 is a cross-sectional view illustrating an adapter in a state where a ferrule is inserted and fitted in an optical connection structure according to a second modification example.

FIG. 8 is a cross-sectional view of the adapter along the VIII-VIII line of FIG. 7.

### DESCRIPTION OF EMBODIMENTS

### Problems to Be Solved by Present Disclosure

The following problems can arise in positioning a plurality of optical fibers and the plurality of optical fibers of a connection counterpart using a guide pin and a ferrule provided with a guide pin insertion hole as in the technique disclosed in Patent Literature 1. For example, in order to position the plurality of optical fibers and the plurality of optical fibers of the connection counterpart with high accuracy, a guide pin with high dimensional accuracy is required such that the clearance between the guide pin insertion hole and the guide pin is as small as possible. Further, in cleaning the ferrule with the guide pin inserted in the guide pin insertion hole, foreign matter such as dust near the guide pin may not be completely removable. In this case, the foreign matter may become a hindrance, the positioning accuracy of the plurality of optical fibers and the plurality of optical fibers of the connection counterpart may decline, and an increase in connection loss may arise.

### ADVANTAGEOUS EFFECTS OF INVENTION

### Effect of Present Disclosure

According to the optical connection structure, the ferrule, and the optical connector according to the present disclosure, it is possible to position a plurality of optical fibers with a simple configuration.

### Description of Embodiment of Present Disclosure

First, the content of an embodiment of the present disclosure will be listed and described. An optical connection structure according to one embodiment of the present disclosure includes: a plurality of optical fibers; a ferrule holding the plurality of optical fibers; and a tubular adapter where the ferrule is inserted and fitted such that the ferrule and another ferrule face each other in the tubular shape. The ferrule has a first side surface and a second side surface facing each other. The first side surface is provided with a first recess portion or a first protrusion portion extending along a first direction in which the ferrule is inserted into the adapter. The second side surface is provided with a second recess portion or a second protrusion portion extending along the first direction. An inner surface of the adapter is provided with a third protrusion portion or a third recess portion fittable with the first recess portion or the first protrusion portion and a fourth protrusion portion or a fourth recess portion fittable with the second recess portion or the second protrusion portion.

In this optical connection structure, when the ferrule is inserted into the adapter and fitted, the first recess portion or the first protrusion portion is fitted to the third protrusion portion or the third recess portion and the second recess portion or the second protrusion portion is fitted to the fourth protrusion portion or the fourth recess portion. As a result, the position of the ferrule with respect to the adapter (that is, the position of the plurality of optical fibers held by the ferrule) can be defined in a plane perpendicular to the first direction. In other words, by using the adapter where the ferrule is inserted and fitted as a positioning member at the time of positioning the plurality of optical fibers, the plurality of optical fibers can be positioned without providing a guide pin insertion hole in the ferrule. As a result, it is not necessary to use a high-dimensional accuracy guide pin for positioning between the plurality of optical fibers (that is, positioning between the plurality of optical fibers and the plurality of optical fibers of the connection counterpart). Further, it is possible to avoid a situation in which the use of a foreign matter-attached guide pin leads to a decline in the positioning accuracy of the plurality of optical fibers. As a result, it is possible to suppress a decline in connection loss between the plurality of optical fibers and the plurality of optical fibers of the connection counterpart. Accordingly, according to the optical connection structure described above, the plurality of optical fibers can be positioned with a simple configuration.

The ferrule may further have a plurality of optical fiber holding portions respectively holding the plurality of optical fibers. The plurality of optical fiber holding portions may be disposed side by side along a second direction intersecting the first direction. In this case, it is possible to suitably realize a configuration in which the plurality of optical fibers are positioned by inserting the ferrule into the adapter and fitting the ferrule.

Each of the first recess portion or the first protrusion portion and the second recess portion or the second protrusion portion may be V-shaped in a cross section perpendicular to the first direction. In this case, the ferrule can be accurately positioned with respect to the adapter. In other words, the positioning of the plurality of optical fibers can be performed with high accuracy.

Each of the third protrusion portion or the third recess portion and the fourth protrusion portion or the fourth recess portion may be V-shaped in a cross section perpendicular to the first direction. In this case, the ferrule can be accurately positioned with respect to the adapter. In other words, the positioning of the plurality of optical fibers can be performed with high accuracy.

The first side surface may be provided with the first recess portion, and the second side surface may be provided with the second recess portion. The inner surface of the adapter may be provided with the third protrusion portion fittable with the first recess portion and the fourth protrusion portion fittable with the second recess portion. In this case, an increase in the width of the ferrule can be suppressed as compared with a case where the first side surface and the second side surface are provided with the first protrusion portion and the second protrusion portion, respectively. In other words, an increase in the size of the ferrule can be suppressed.

The first recess portion or the first protrusion portion may be capable of coming into contact with the third protrusion portion or the third recess portion and the second recess portion or the second protrusion portion may be capable of coming into contact with the fourth protrusion portion or the fourth recess portion in a plane perpendicular to the first direction. In this case, a positional deviation of the ferrule with respect to the adapter can be suppressed, and thus the positioning of the plurality of optical fibers can be performed with high accuracy.

At least one of the third protrusion portion or the third recess portion and the fourth protrusion portion or the fourth recess portion may be configured to be elastically deformable in a second direction intersecting the first direction. In this case, the ferrule can be easily inserted into the adapter, and thus the workability in inserting the ferrule into the adapter is improved. Further, when the ferrule is inserted into the adapter, in a case where the first recess portion or the first protrusion portion and the second recess portion or the second protrusion portion respectively abut against the third protrusion portion or the third recess portion and the fourth protrusion portion or the fourth recess portion, a force that causes at least one of the third protrusion portion or the third recess portion and the fourth protrusion portion or the fourth recess portion to return to the original position is applied to the ferrule. As a result, the ferrule is held and fixed by the third protrusion portion or the third recess portion and the fourth protrusion portion or the fourth recess portion, and thus a positional deviation of the ferrule with respect to the adapter is suppressed. As a result, the positioning of the plurality of optical fibers can be performed with high accuracy.

The adapter may have a pair of regions positioned on both sides in the second direction with the third protrusion portion or the third recess portion and the fourth protrusion portion or the fourth recess portion interposed between the regions and respectively provided with the third protrusion portion or the third recess portion and the fourth protrusion portion or the fourth recess portion. A hollow portion may be provided in the region as one of the pair of regions where at least one of the third protrusion portion or the third recess portion and the fourth protrusion portion or the fourth recess portion is provided. In this case, at least one of the third protrusion portion or the third recess portion and the fourth protrusion portion or the fourth recess portion can be elastically deformed with ease in the second direction. As a result, the ferrule can be more easily inserted into the adapter, and thus the workability in inserting the ferrule into the adapter is further improved.

A ferrule according to one embodiment of the present disclosure includes: a plurality of optical fiber holding portions for respectively holding a plurality of optical fibers; and a first side surface and a second side surface facing each other. The first side surface is provided with a first recess portion or a first protrusion portion extending along a first direction in which the plurality of optical fiber holding portions extend. The second side surface is provided with a second recess portion or a second protrusion portion extending along the first direction.

When this ferrule is inserted into the adapter and fitted, by using the first recess portion or the first protrusion portion and the second recess portion or the second protrusion portion as positioning guides with respect to the adapter, the position of the ferrule with respect to the adapter (that is, the position of the plurality of optical fibers held by the ferrule) can be defined in a plane perpendicular to the first direction. In other words, by using the adapter where the ferrule is inserted and fitted as a positioning member at the time of positioning the plurality of optical fibers, the plurality of optical fibers can be positioned without providing a guide pin insertion hole in the ferrule. As a result, it is not necessary to use a high-dimensional accuracy guide pin for positioning between the plurality of optical fibers. Further, it is possible to avoid a situation in which the use of a foreign matter-attached guide pin leads to a decline in the positioning accuracy of the plurality of optical fibers. As a result, it is possible to suppress a decline in connection loss between the plurality of optical fibers and the plurality of optical fibers of the connection counterpart. Accordingly, according to the ferrule described above, the plurality of optical fibers can be positioned with a simple configuration.

The plurality of optical fiber holding portions may be disposed side by side along a second direction intersecting the first direction. In this case, it is possible to suitably realize a configuration in which the plurality of optical fibers are positioned by inserting the ferrule into the adapter and fitting the ferrule.

Each of the first recess portion or the first protrusion portion and the second recess portion or the second protrusion portion may be V-shaped in a cross section perpendicular to the first direction. In this case, the ferrule can be accurately positioned with respect to the adapter. In other words, the positioning of the plurality of optical fibers can be performed with high accuracy.

An optical connector according to one embodiment of the present disclosure includes: the ferrule according to any of the above; and the plurality of optical fibers respectively held in the plurality of optical fiber holding portions. Since this optical connector includes the ferrule according to any of the above, the plurality of optical fibers can be positioned with a simple configuration as described above.

### Details of Embodiment of Present Disclosure

Hereinafter, one embodiment of the present disclosure will be described in detail with reference to the drawings. In the following description, the same reference numerals will be used for the same or functionally identical elements with redundant description omitted.

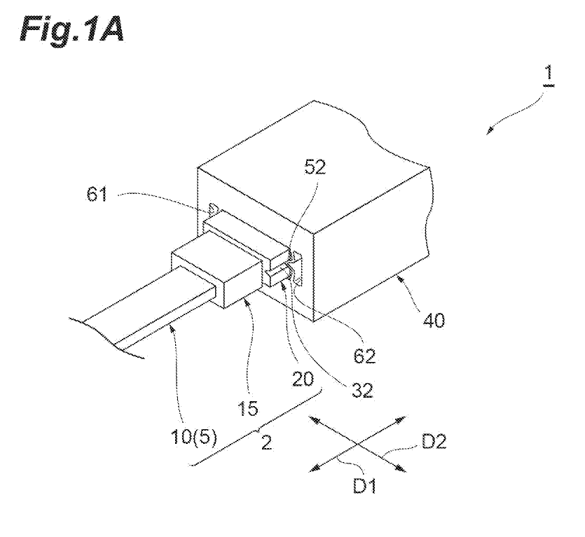

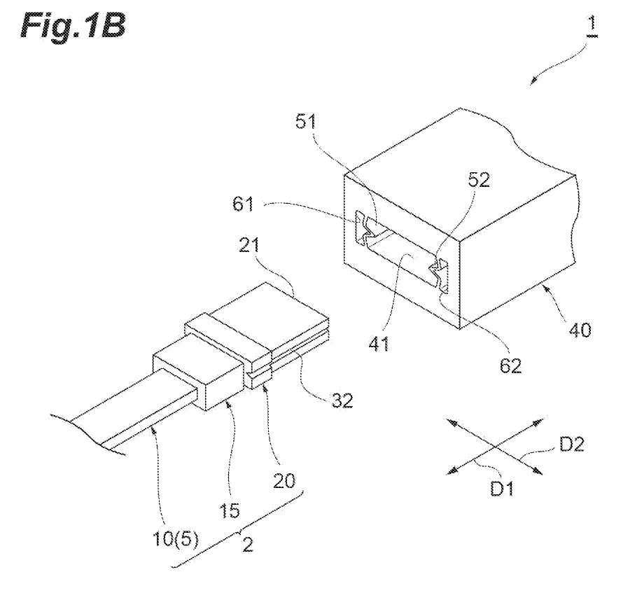

FIG. 1A is a perspective view illustrating a state where an optical connector 2 is attached to an adapter 40 in an optical connection structure 1 according to the present embodiment. FIG. 1B is a perspective view illustrating a state where the optical connector 2 is removed from the adapter 40 in the optical connection structure 1 according to the present embodiment. As illustrated in FIGS. 1A and 1B, the optical connection structure 1 includes the optical connector 2 and the adapter 40 into which the optical connector 2 is inserted. The optical connector 2 has an optical fiber tape core wire 5 accommodating a plurality of optical fibers 10 and a ferrule 20 attached to the tip portion of the optical fiber tape core wire 5 via a boot 15.

The ferrule 20 has, for example, a substantially rectangular parallelepiped appearance. The ferrule 20 is configured by, for example, a material such as polyphenylene sulfide (PPS), polyetherimide (PEI), polycarbonate (PC), polymethylmethacrylate (PMMA), and polyethersulfone (PES). The ferrule 20 is inserted into the adapter 40 along, for example, a direction D1 and fitted to the adapter 40.

The adapter 40 has a tubular shape capable of accommodating the ferrule 20. The adapter 40 is fitted with the ferrule 20 such that a tip surface 21 of the ferrule 20 and the tip surface of a connection counterpart ferrule (not illustrated) face each other in the adapter 40. The adapter 40 is configured by, for example, an elastic material having elasticity such as polyetherimide (PEI), polybutylene terephthalate (PBT), polyphenylene sulfide (PPS), polycarbonate (PC), polymethylmethacrylate (PMMA), polyethersulfone (PES), and polyamide (PA). In order to reduce the difference between the coefficient of linear expansion of the material of the adapter 40 and the coefficient of linear expansion of the material of the ferrule 20, it is preferable to use the same material as the ferrule 20 as the material of the adapter 40. The material of the adapter 40 may contain a filler or an additive for slidability improvement. In the adapter 40, the tip surface of the ferrule 20 and the tip surface of the connection counterpart ferrule may be in contact with each other by abutting against each other or may be separated from each other with a predetermined distance.

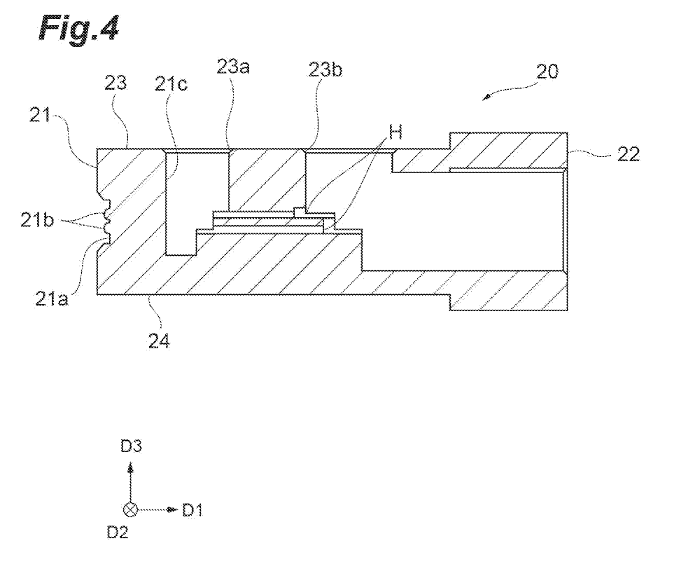

The plurality of optical fibers 10 of the optical fiber tape core wire 5 extend along the direction D1 and are disposed side by side along a direction D2 intersecting (for example, orthogonal to) the direction D1. In the optical fiber tape core wire 5, the plurality of optical fibers 10 are disposed so as to overlap in a plurality of stages. The plurality of optical fibers 10 are inserted along the direction D1 into a plurality of optical fiber holes H (see FIG. 4 to be described later) formed in the ferrule 20.

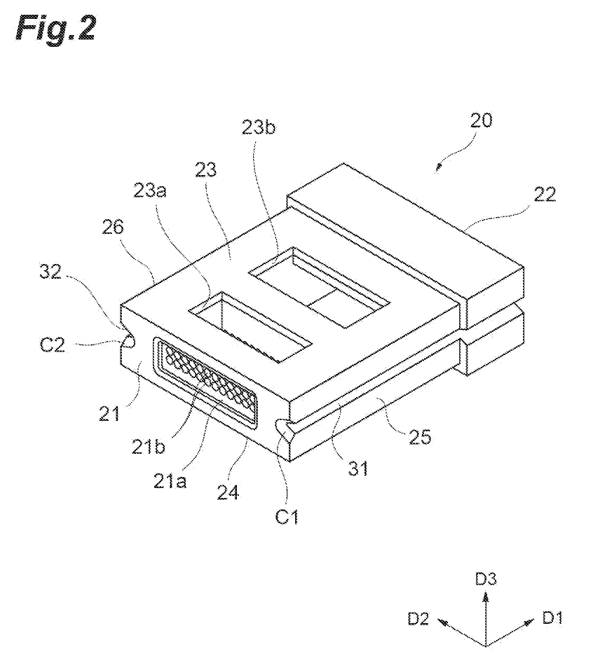

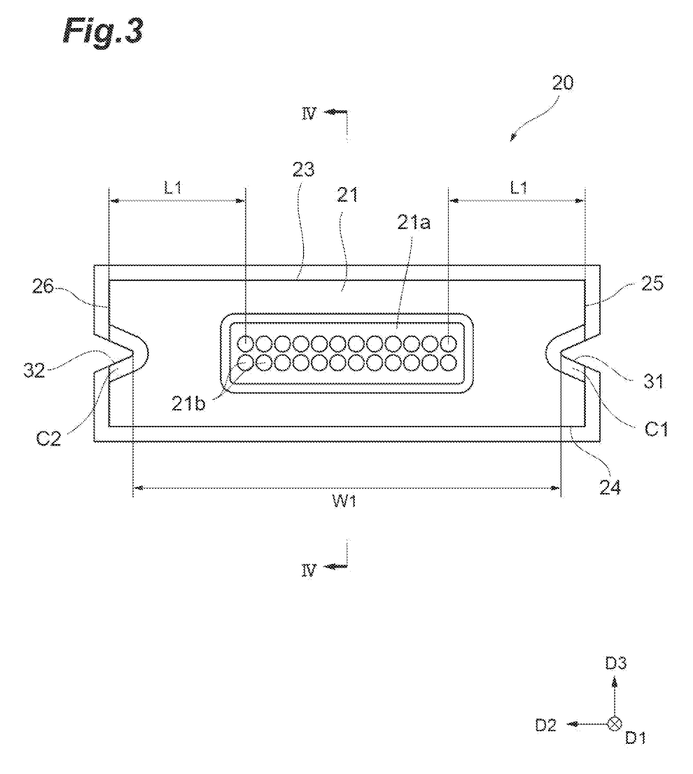

Next, the shape of the ferrule 20 will be described in detail with reference to FIGS. 2, 3, and 4. FIG. 2 is a perspective view illustrating the ferrule 20. FIG. 3 is a front view illustrating the ferrule 20. FIG. 4 is a cross-sectional view of the ferrule 20 along the IV-IV line of FIG. 3. As illustrated in FIGS. 2, 3, and 4, the longitudinal direction of the ferrule 20 is along the direction D1, the lateral direction of the ferrule 20 is along the direction D2, and the thickness direction of the ferrule 20 (that is, up-down direction) is along a direction D3 intersecting (for example, orthogonal to) the directions D1 and D2. The ferrule 20 has the tip surface 21 positioned at the tip in the direction D1, a rear end surface 22 positioned at the rear end in the direction D1, and four side surfaces 23, 24, 25, and 26 connecting the tip surface 21 and the rear end surface 22 and extending along the direction D1.

As illustrated in FIGS. 2 and 4, the tip surface 21 and the rear end surface 22 extend along the directions D2 and D3. A light transmitting surface 21a is provided in the middle portion of the tip surface 21. The light transmitting surface 21a is slightly recessed to the rear end surface 22 side in the direction D1 with respect to the tip surface 21. The light transmitting surface 21a is provided with a plurality of lenses 21b. The optical axes of the lenses 21b are disposed so as to respectively overlap the central axes of the optical fibers 10 when viewed from the direction D1. The optical fibers 10 respectively abut against back surfaces 21c of the lenses 21b (that is, surfaces positioned on the side opposite to each lens 21b in the direction D1). The light emitted from the optical fibers 10 is collimated by the respective lenses 21b and then incident on the respective optical fibers of the connection counterpart. The central axis of the optical fiber 10 and the optical axis of the lens 21b may be deviated from each other in order to suppress the reflected return light to the end surface of the optical fiber 10. Likewise, the end surface of the optical fiber 10 or the surface of the lens 21b may be inclined by, for example, 8° with respect to the direction D3 for the purpose of suppressing reflected return light.

The side surfaces 23 and 24 face each other in the direction D3 and extend along the directions D1 and D2. In one example, the side surfaces 23 and 24 extend parallel to each other. The side surface 23 is provided with openings 23a and 23b. The opening 23a is positioned on the tip surface 21 side in the direction D1 with respect to the opening 23b. As illustrated in FIG. 4, the plurality of optical fiber holes H for respectively holding the plurality of optical fibers 10 are provided in the ferrule 20. The plurality of optical fiber holes H extend along the direction D1 and are disposed side by side along the direction D2. The plurality of optical fibers 10 are respectively inserted into and fixed to the plurality of optical fiber holes H. The plurality of optical fiber holes H penetrate the ferrule 20 between the openings 23a and 23b. The plurality of optical fiber holes H are disposed so as to correspond to the plurality of optical fibers 10. The plurality of optical fibers 10 are respectively inserted into the plurality of optical fiber holes H. An adhesive is injected into the ferrule 20 from the openings 23a and 23b. As a result, the space formed in the ferrule 20 is filled with the adhesive, and the positions of the optical fibers 10 respectively inserted in the optical fiber holes H are fixed. Although a structure in which the optical fibers 10 are inserted into and fixed to the optical fiber holes H have been described here, V-grooves may be formed in the ferrule 20 as an optical fiber holding portion. In this case and structure, the optical fibers 10 may be placed on the V-grooves and the optical fibers 10 may be pressed by a lid member from above the V-grooves.

As illustrated in FIGS. 2 and 3, the side surfaces 25 and 26 face each other in the direction D2 and extend along the directions D1 and D3. In one example, the side surfaces 25 and 26 extend parallel to each other. The side surface 25 is provided with a V-groove 31 extending along the direction D1. The side surface 26 is provided with a V-groove 32 extending along the direction D1. The V-grooves 31 and 32 are V-shaped in a cross section perpendicular to the direction D1. The V-grooves 31 and 32 are, for example, provided so as to continuously extend from the tip surface 21 to the rear end surface 22 along the direction D1. In other words, the V-grooves 31 and 32 extend over the entire length of the ferrule 20 in the direction D1. The V-grooves 31 and 32 are provided at positions facing each other in the direction D2. In other words, when viewed from the direction D2, the position of the V-groove 31 in the side surface 25 coincides with the position of the V-groove 32 in the side surface 26. The V-groove 31 is positioned in, for example, the middle portion of the side surface 25 in the direction D3, and the V-groove 32 is positioned in, for example, the middle portion of the side surface 26 in the direction D3.

In a cross section perpendicular to the direction D1, the opening angle of the V-groove 31 (that is, the angle formed by the pair of surfaces configuring the V-groove 31) is, for example, 45° or more and 120° or less. The opening angle of the V-groove 31 may be, for example, 60° or more and 100° or less, or may be 90°. In the present embodiment, in a cross section perpendicular to the direction D1, the bottom portion of the V-groove 31 is, for example, rounded and the diameter of the inscribed circle in contact with the roundness is set to, for example, 0.7 mm. The V-groove 32 has, for example, the same shape as the V-groove 31.

FIG. 3 illustrates a shortest distance W1 between the V-groove 31 and the V-groove 32 facing each other along the direction D2. The shortest distance W1 can be defined as the shortest distance between the bottom portion of the V-groove 31 and the bottom portion of the V-groove 32 in the direction D2.

In the present embodiment, no guide pin insertion hole is provided between the side surface 25 and the plurality of lenses 21b. Accordingly, a distance L1 between the side surface 25 and the plurality of lenses 21b can be set without considering the outer diameter of a guide pin insertion hole. As a result, the distance L1 between the side surface 25 and the plurality of lenses 21b can be set smaller than the shortest distance between the side surface 25 and the plurality of lenses 21b in a case where a guide pin insertion hole is provided. The distance L1 between the side surface 26 and the plurality of lenses 21b (specifically, the lens 21b closest to the side surface 26 in the direction D2) in the direction D2 can be set in the same manner as the distance L1 between the side surface 25 and the plurality of lenses 21b in the direction D2. As a result, the maximum width of the ferrule 20 in the direction D2 (that is, the maximum distance between the side surface 25 and the side surface 26 in the direction D2) can be smaller than the maximum width of the ferrule in the direction D2 in a case where a guide pin insertion hole is provided. Accordingly, the ferrule 20 can be reduced in size.

As illustrated in FIGS. 2 and 3, a chamfered portion C1 is provided at the part where the tip surface 21 and the V-groove 31 intersect. The chamfered portion C1 is formed so as to have a reverse taper shape from the tip surface 21 to the V-groove 31 and is continuously connected to the V-groove 31. The chamfered portion C1 may be smoothly connected to the V-groove 31. A chamfered portion C2 is provided at the part where the tip surface 21 and the V-groove 32 intersect. The chamfered portion C2 has the same shape as the chamfered portion C1. The chamfered portion C2 is continuously connected to the V-groove 32. The chamfered portion C2 may be smoothly connected to the V-groove 32.

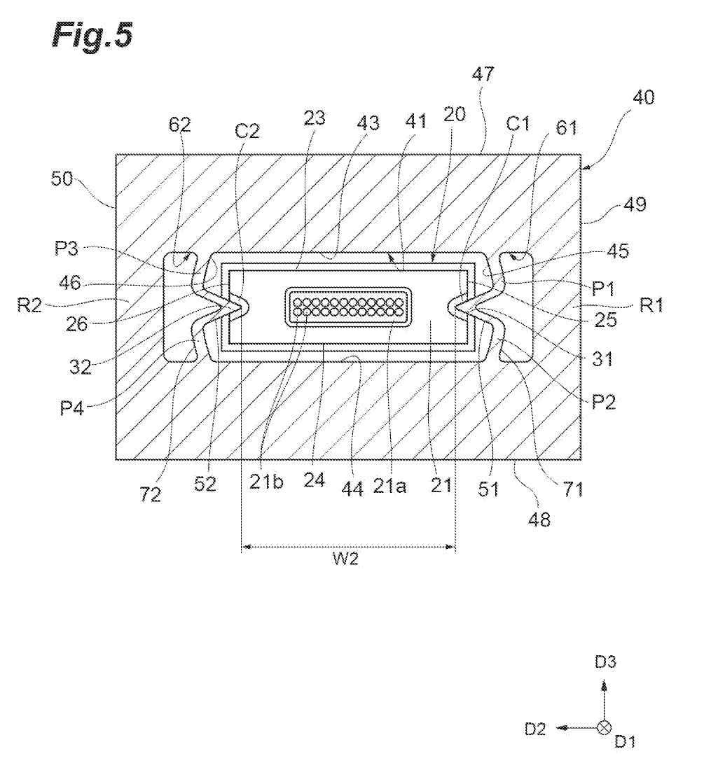

Next, the shape of the adapter 40 will be described in detail with reference to FIG. 5. FIG. 5 is a cross-sectional view illustrating the adapter 40 in a state where the ferrule 20 is inserted and fitted. As illustrated in FIG. 5, the adapter 40 has, for example, a rectangular tube shape extending along the direction D1. The total length of the adapter 40 in the direction D1 is, for example, longer than the total length of the ferrule 20 in the direction D1.

As illustrated in FIG. 5, the adapter 40 has an insertion hole 41 configuring the inside of the rectangular tube shape. The insertion hole 41 penetrates the adapter 40 along the direction D1. The insertion hole 41 has a rectangular shape when viewed from the direction D1 and is configured by four inner surfaces 43, 44, 45, and 46. The inner surfaces 43 and 44 face each other in the direction D3 and extend along the directions D1 and D2. The inner surface 43 faces the side surface 23 of the ferrule 20 in the direction D3. In one example, the inner surface 43 extends parallel to the side surface 23. The inner surface 44 faces the side surface 24 of the ferrule 20 in the direction D3. In one example, the inner surface 44 extends parallel to the side surface 24.

The inner surfaces 45 and 46 face each other in the direction D2 and extend along the directions D1 and D3. The inner surface 45 faces the side surface 25 of the ferrule 20 in the direction D2. The inner surface 45 may extend parallel to the side surface 25. The inner surface 46 faces the side surface 26 of the ferrule 20 in the direction D2. The inner surface 46 may extend parallel to the side surface 26. The adapter 40 has four outer surfaces 47, 48, 49, and 50 configuring the outer shape of the rectangular tube shape. The outer surfaces 49 and 50 do not necessarily have to configure the outer shape of the rectangular tube shape. For example, the outer surfaces of V-protrusions 51 and 52 may be exposed to the outside of the adapter 40.

The inner surface 45 is provided with the V-protrusion 51 extending along the direction D1. The inner surface 46 is provided with the V-protrusion 52 extending along the direction D1. The V-protrusions 51 and 52 are V-shaped in a cross section perpendicular to the direction D1. The V-protrusion 51 is, for example, provided on the inner surface 45 so as to continuously extend over the direction D1. In other words, the V-protrusion 51 extends over the entire length of the adapter 40 in the direction D1. The V-protrusion 52 is, for example, provided on the inner surface 46 so as to continuously extend over the direction D1. In other words, the V-protrusion 52 extends over the entire length of the adapter 40 in the direction D1. The length of the V-protrusion 51 in the direction D1 is longer than, for example, the length of the V-groove 31 in the direction D1. The length of the V-protrusion 52 in the direction D1 is longer than, for example, the length of the V-groove 32 in the direction D1. The V-protrusions 51 and 52 are provided at positions facing each other in the direction D2. In other words, when viewed from the direction D2, the position of the V-protrusion 51 on the inner surface 45 coincides with the position of the V-protrusion 52 on the inner surface 46.

The V-protrusions 51 and 52 are provided so as to guide the V-grooves 31 and 32 of the ferrule 20, respectively. The V-protrusion 51 is provided so as to be fittable with the V-groove 31 of the ferrule 20. In other words, the V-protrusion 51 is provided at a position facing the V-groove 31 in the direction D2 and has a shape corresponding to the V-groove 31. In a cross section perpendicular to the direction D1, the angle of the V-protrusion 51 (that is, the angle formed by the pair of surfaces configuring the V-protrusion 51) is, for example, 45° or more and 120° or less. The angle of the V-protrusion 51 may be, for example, 60° or more and 100° or less, or may be 90°. In the present embodiment, in a cross section perpendicular to the direction D1, the top portion of the V-protrusion 51 is, for example, rounded and the diameter of the inscribed circle in contact with the roundness is set to, for example, 0.7 mm.

The V-protrusion 52 is provided so as to be fittable with the V-groove 32 of the ferrule 20. In other words, the V-protrusion 52 is provided at a position facing the V-groove 32 in the direction D2 and has a shape corresponding to the V-groove 32. The V-protrusion 52 has, for example, the same shape as the V-protrusion 51. FIG. 5 illustrates a shortest distance W2 between the V-protrusion 51 and the V-protrusion 52 facing each other along the direction D2. The shortest distance W2 can be defined as the shortest distance between the top portion of the V-protrusion 51 and the top portion of the V-protrusion 52 in the direction D2 in a state where the ferrule 20 is not inserted in the adapter 40.

The adapter 40 has a pair of regions R1 and R2 outside the insertion hole 41 in the direction D2. The pair of regions R1 and R2 are positioned on both sides in the direction D2 with the V-protrusions 51 and 52 interposed therebetween. One region R1 is at a position sandwiched between the inner surface 45 and the outer surface 49 in the direction D2. The other region R2 is at a position sandwiched between the inner surface 46 and the outer surface 50 in the direction D2. The pair of regions R1 and R2 are provided with a pair of hollow holes 61 and 62, respectively. The hollow holes 61 and 62 extend along, for example, the V-protrusions 51 and 52, respectively. In other words, the hollow holes 61 and 62 extend over, for example, the entire length of the adapter 40 in the direction D1. Each of the hollow holes 61 and 62 has, for example, a substantially rectangular shape when viewed from the direction D1.

The hollow hole 61 is adjacent to the inner surface 45 of the insertion hole 41 at a predetermined interval in the direction D2. In the region R1, the region sandwiched between the hollow hole 61 and the insertion hole 41 in the direction D2 is configured as a wall portion 71 separating the hollow hole 61 and the insertion hole 41. The thickness of the wall portion 71 is, for example, constant. The wall portion 71 extends along the direction D3 between the hollow hole 61 and the insertion hole 41. Specifically, the wall portion 71 extends along the shape of the inner surface 45 provided with the V-protrusion 51. The part of the wall portion 71 where the V-protrusion 51 is provided protrudes toward the ferrule 20 side in the direction D2 so as to follow the shape of the V-protrusion 51.

The wall portion 71 includes a pair of parts P1 and P2 connected to the part provided with the V-protrusion 51 at the positions where the part provided with the V-protrusion 51 is sandwiched in the direction D3. The parts P1 and P2 extend along a direction slightly inclined from the direction D3 in the cross section illustrated in FIG. 5. In the cross section illustrated in FIG. 5, each of the inclination angles of the part P1 and the part P2 with respect to the direction D3 is, for example, 5° or more and 15° or less. The part P1 is inclined so as to be positioned on the side opposite to the ferrule 20 in the direction D2 from the inner surface 43 toward the V-protrusion 51 in the direction D3. The part P2 is inclined so as to be positioned on the side opposite to the ferrule 20 in the direction D2 from the inner surface 44 toward the V-protrusion 51 in the direction D3.

The hollow hole 62 is adjacent to the inner surface 46 of the insertion hole 41 at a predetermined interval in the direction D2. In the region R2, the region sandwiched between the hollow hole 62 and the insertion hole 41 in the direction D2 is configured as a wall portion 72 separating the hollow hole 62 and the insertion hole 41. The thickness of the wall portion 72 is, for example, constant. The wall portion 72 extends along the direction D3 between the hollow hole 62 and the insertion hole 41. Specifically, the wall portion 72 extends along the shape of the inner surface 46 provided with the V-protrusion 52. The part of the wall portion 72 where the V-protrusion 52 is provided protrudes toward the ferrule 20 side in the direction D2 so as to follow the shape of the V-protrusion 52.

The wall portion 72 includes a pair of parts P3 and P4 connected to the part provided with the V-protrusion 52 at the positions where the part provided with the V-protrusion 52 is sandwiched in the direction D3. The parts P3 and P4 extend along a direction slightly inclined from the direction D3 in the cross section illustrated in FIG. 5. In the cross section illustrated in FIG. 5, each of the inclination angles of the part P3 and the part P4 with respect to the direction D3 is, for example, 5° or more and 15° or less. The part P3 is inclined so as to be positioned on the side opposite to the ferrule 20 in the direction D2 from the inner surface 43 toward the V-protrusion 52 in the direction D3. The part P4 is inclined so as to be positioned on the side opposite to the ferrule 20 in the direction D2 from the inner surface 44 toward the V-protrusion 52 in the direction D3.

By each of the wall portion 71 and the wall portion 72 having a part inclined from the direction D3 as described above, stress concentration on the base portion of the wall portion 71 (that is, the connection parts between the inner surfaces 43 and 44 and the wall portion 71) and the base portion of the wall portion 72 (that is, the connection parts between the inner surfaces 43 and 44 and the wall portion 72) can be suppressed as compared with a case where each of the wall portion 71 and the wall portion 72 is provided in parallel with the direction D3. As a result, damage to each of the wall portion 71 and the wall portion 72 can be suppressed.

When the ferrule 20 described above is inserted into the adapter 40 and fitted, the ferrule 20 and the adapter 40 are disposed such that the tip surface 21 of the ferrule 20 is first inserted into the adapter 40 as illustrated in FIG. 1A. Then, the ferrule 20 is inserted into the adapter 40 by moving the ferrule 20 along the direction D1 with respect to the adapter 40. When the ferrule 20 is inserted into the adapter 40, the V-grooves 31 and 32 of the ferrule 20 are fitted to the V-protrusions 51 and 52 of the adapter 40, respectively. At this time, the V-protrusion 51 enters the V-groove 31 and abuts and the V-protrusion 52 enters the V-groove 32 and abuts.

Here, in a case where the shortest distance W1 between the V-groove 31 and the V-groove 32 of the ferrule 20 is larger than the shortest distance W2 between the V-protrusion 51 and the V-protrusion 52 of the adapter 40 as in the present embodiment, the V-protrusions 51 and 52 of the adapter 40 enter the V-grooves 31 and 32 of the ferrule 20 in a state of being compressed in the direction D2. In other words, the V-protrusions 51 and 52 of the adapter 40 receive a reaction force from the V-grooves 31 and 32 of the ferrule 20 and are elastically deformed to the side opposite to the ferrule 20 in the direction D2 (that is, the outside of the adapter 40). Then, a force that causes the V-protrusions 51 and 52 facing each other to return to the original positions is applied to the ferrule 20, and the ferrule 20 is held and fixed by the V-protrusions 51 and 52.

As a result, the V-protrusions 51 and 52 respectively come into contact with the V-grooves 31 and 32, and each of the gap between the V-protrusion 51 and the V-groove 31 in the direction D2 and the gap between the V-protrusion 52 and the V-groove 32 in the direction D2 becomes zero. As a result, the position of the ferrule 20 with respect to the adapter 40 is defined in the directions D2 and D3, and the rotation-direction position of the ferrule 20 with respect to the adapter 40 is defined. Subsequently, a spring (not illustrated) attached to the rear of the ferrule 20 urges the ferrule 20 to the connection counterpart ferrule side in the direction D1. Accordingly, the position of the ferrule 20 in the direction D1 with respect to the adapter 40 is defined. The plurality of optical fibers 10 are positioned in this manner.

In a case where there are a gap in the direction D3 between the V-protrusion 51 and the V-groove 31 (that is, difference between the width of the V-protrusion 51 and the width of the V-groove 31) and a gap in the direction D3 between the V-protrusion 52 and the V-groove 32 (that is, difference between the width of the V-protrusion 52 and the width of the V-groove 32), the sizes of these gaps may result in a positional deviation or an angular deviation between the ferrule 20 and the connection counterpart ferrule. Therefore, it is desirable that these gaps are set to be as small as possible.

In the present embodiment, the V-protrusions 51 and 52 configure a part of the adapter 40 configured by an elastic material. Accordingly, in the present embodiment, both the V-protrusions 51 and 52 are configured to be elastically deformable. In an alternative configuration, only one of the V-protrusions 51 and 52 may be elastically deformable. In this case, a hollow hole may be provided only in the region that is one of the regions R1 and R2 and provided with either the V-protrusion 51 or the V-protrusion 52. In other words, a hollow hole may be provided in one region provided with one V-protrusion that is elastically deformed and no hollow hole may be provided in the other region provided with the other V-protrusion that is not elastically deformed.

For example, in a case where only the V-protrusion 51 is configured to be elastically deformable, the hollow hole 61 may be provided in the region R1 provided with the V-protrusion 51 with the hollow hole 62 not provided in the region R2 provided with the V-protrusion 52. In this case, when the ferrule 20 is inserted into the adapter 40 and fitted, the V-groove 32 of the ferrule 20 is disposed so as to abut against the V-protrusion 52 that is not elastically deformed and the V-groove 31 of the ferrule 20 is caused to abut against the V-protrusion 51 that is elastically deformed. At this time, the V-protrusion 51 receives a reaction force from the V-groove 31 and is elastically deformed. Then, by a force that causes the V-protrusion 51 to return to the original position being applied to the ferrule 20, the ferrule 20 is held and fixed by the V-protrusions 51 and 52. As a result, the position of the ferrule 20 with respect to the adapter 40 is defined as in a case where both the V-protrusions 51 and 52 are configured to be elastically deformable. Likewise, in a case where only the V-protrusion 52 is configured to be elastically deformable, the hollow hole 62 may be provided in the region R2 provided with the V-protrusion 52 with the hollow hole 61 not provided in the region R1 provided with the V-protrusion 51. Also in this case, the position of the ferrule 20 with respect to the adapter 40 is defined by the V-protrusion 52 being elastically deformed.

The effects of the optical connection structure 1, the ferrule 20, and the optical connector 2 according to the present embodiment described above will be described. In the optical connection structure 1, the ferrule 20, and the optical connector 2 according to the present embodiment, when the ferrule 20 is inserted into the adapter 40 and fitted, the V-groove 31 is fitted to the V-protrusion 51 and the V-groove 32 is fitted to the V-protrusion 52. As a result, the position of the ferrule 20 with respect to the adapter 40 (that is, the position of the plurality of optical fibers 10 held by the ferrule 20) can be defined in a plane perpendicular to the direction D1. In other words, by using the adapter 40 where the ferrule 20 is inserted and fitted as a positioning member at the time of positioning of the plurality of optical fibers 10, the plurality of optical fibers 10 can be positioned without providing a guide pin insertion hole in the ferrule 20. As a result, it is not necessary to use a high-dimensional accuracy guide pin for positioning between the plurality of optical fibers 10 (that is, positioning between the plurality of optical fibers 10 and the plurality of optical fibers of the connection counterpart). Further, it is possible to avoid a situation in which the use of a foreign matter-attached guide pin leads to a decline in the positioning accuracy of the plurality of optical fibers 10. As a result, it is possible to suppress a decline in connection loss between the plurality of optical fibers 10 and the plurality of optical fibers of the connection counterpart. Accordingly, according to the optical connection structure 1, the ferrule 20, and the optical connector 2 according to the present embodiment, the plurality of optical fibers 10 can be positioned with a simple configuration.

In a case where the optical connection of the plurality of optical fibers 10 is performed using the plurality of lenses 21b provided on the tip surface 21 of the ferrule 20 as in the present embodiment, it is desirable to make as small as possible the angular deviation between the plurality of optical fibers 10 and the plurality of optical fibers of the connection counterpart. In the optical connection structure 1, by performing the optical connection of the plurality of optical fibers 10 using the V-grooves 31 and 32 provided over the entire length of the ferrule 20 (for example, 8 mm), it is possible to accurately regulate the rotation direction of the plurality of optical fibers 10 with respect to the plurality of optical fibers of the connection counterpart as compared with a case where the optical connection of a plurality of optical fibers is performed using the protrusion length of a guide pin (for example, 2 mm) that slightly protrudes from the insertion hole of a ferrule. Accordingly, according to the present embodiment, the angular deviation between the plurality of optical fibers 10 and the plurality of optical fibers of the connection counterpart can be suppressed to be smaller, and thus it is suitable for suppressing a decline in the connection loss between the plurality of optical fibers 10 and the plurality of optical fibers of the connection counterpart.

In the present embodiment, the plurality of optical fiber holes H are disposed side by side along the direction D2. According to this configuration, it is possible to suitably realize a configuration in which the plurality of optical fibers 10 are positioned by inserting the ferrule 20 into the adapter 40 and fitting the ferrule 20.

In the present embodiment, each of the V-groove 31 and the V-groove 32 is V-shaped in a cross section perpendicular to the direction D1. Each of the V-protrusion 51 and the V-protrusion 52 is V-shaped in a cross section perpendicular to the direction D1. In this configuration, the ferrule 20 can be accurately positioned with respect to the adapter 40 by fitting the V-groove 31 and the V-groove 32 to the V-protrusion 51 and the V-protrusion 52, respectively. In other words, the positioning of the plurality of optical fibers 10 can be performed with high accuracy.

In the present embodiment, the side surface 25 is provided with the V-groove 31. The side surface 26 is provided with the V-groove 32. The inner surfaces 45 and 46 of the adapter 40 are provided with the V-protrusion 51 that can be fitted to the V-groove 31 and the V-protrusion 52 that can be fitted to the V-groove 32. As a result, an increase in the width of the ferrule 20 in the direction D2 can be suppressed as compared with a case where a V-protrusion is provided on each of the side surface 25 and the side surface 26. In other words, an increase in the size of the ferrule 20 can be suppressed.

In the present embodiment, the V-groove 31 is in contact with the V-protrusion 51 and the V-groove 32 is in contact with the V-protrusion 52 in a plane perpendicular to the direction D1. As a result, a positional deviation of the ferrule 20 with respect to the adapter 40 can be suppressed, and thus the positioning of the plurality of optical fibers 10 can be performed with high accuracy.

In the present embodiment, each of the V-protrusions 51 and 52 is configured to be elastically deformable in the direction D2. As a result, the ferrule 20 can be easily inserted into the adapter 40, and thus the workability in inserting the ferrule 20 into the adapter 40 is improved.

In the present embodiment, the shortest distance W1 between the V-groove 31 and the V-groove 32 is larger than the shortest distance W2 between the V-protrusion 51 and the V-protrusion 52 in a plane perpendicular to the direction D1. In this configuration, when the ferrule 20 is inserted into the adapter 40, the V-grooves 31 and 32 respectively abut against the V-protrusions 51 and 52 and a force that causes the V-protrusions 51 and 52 to return to the original positions is applied to the ferrule 20. As a result, the ferrule 20 is held and fixed by the V-protrusions 51 and 52, and thus a positional deviation of the ferrule 20 with respect to the adapter 40 is suppressed. In other words, it is possible to suppress a situation in which a gap in the direction D2 between the V-protrusion 51 and the V-groove 31 and a gap in the direction D2 between the V-protrusion 52 and the V-groove 32 are generated due to the effect of, for example, the manufacturing tolerances of the ferrule 20 and the adapter 40. As a result, the positioning of the plurality of optical fibers 10 can be performed with high accuracy.

In the present embodiment, the hollow holes 61 and 62 are provided in the regions R1 and R2 of the adapter 40, respectively. As a result, the V-protrusions 51 and 52 can be elastically deformed with ease in the direction D2. As a result, the ferrule 20 can be more easily inserted into the adapter 40, and thus the workability in inserting the ferrule 20 into the adapter 40 is further improved.

The present disclosure is not limited to the embodiment described above and can be appropriately modified without departing from the spirit described in the claims.

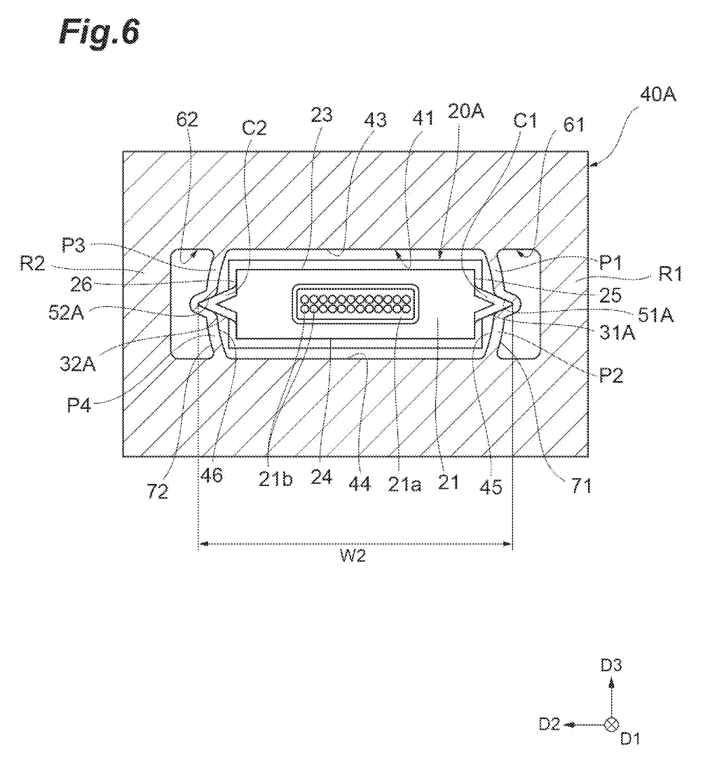

FIG. 6 is a cross-sectional view illustrating an adapter 40A in a state where a ferrule 20A is inserted in an optical connection structure according to a first modification example. As illustrated in FIG. 6, a V-protrusion 31A and a V-protrusion 32A instead of the V-grooves 31 and 32 may be provided on the side surfaces 25 and 26 of the ferrule 20A. In this case, the inner surfaces 45 and 46 of the adapter 40A may be provided with a V-groove 51A and a V-groove 52A instead of the V-protrusions 51 and 52. In this modification example, when the ferrule 20A is inserted into the adapter 40A and fitted, the V-protrusions 31A and 32A of the ferrule 20A respectively enter the V-grooves 51A and 52A of the adapter 40A and abut. Accordingly, the optical connection structure according to this modification example also has the same action and effect as the optical connection structure 1 according to the embodiment described above.

As in the case of the optical connection structure 1 according to the embodiment described above, in the optical connection structure according to this modification example, it is not necessary that both the V-grooves 51A and 52A are configured to be elastically deformable and only one of the V-grooves 51A and 52A may be configured to be elastically deformable. In this case, a hollow hole may be provided only in the region that is one of the pair of regions R1 and R2 and provided with either the V-groove 51A or the V-groove 52A. For example, in a case where only the V-groove 51A is configured to be elastically deformable, the hollow hole 61 may be provided in the region R1 provided with the V-groove 51A with the hollow hole 62 not provided in the region R2 provided with the V-groove 52A. In a case where only the V-groove 52A is configured to be elastically deformable, the hollow hole 62 may be provided in the region R2 provided with the V-groove 52A with the hollow hole 61 not provided in the region R1 provided with the V-groove 51A. Even in such a case, when the ferrule 20A is inserted into the adapter 40A and fitted, the position of the ferrule 20A with respect to the adapter 40A is defined by one of the V-grooves 51A and 52A that is elastically deformable being elastically deformed.

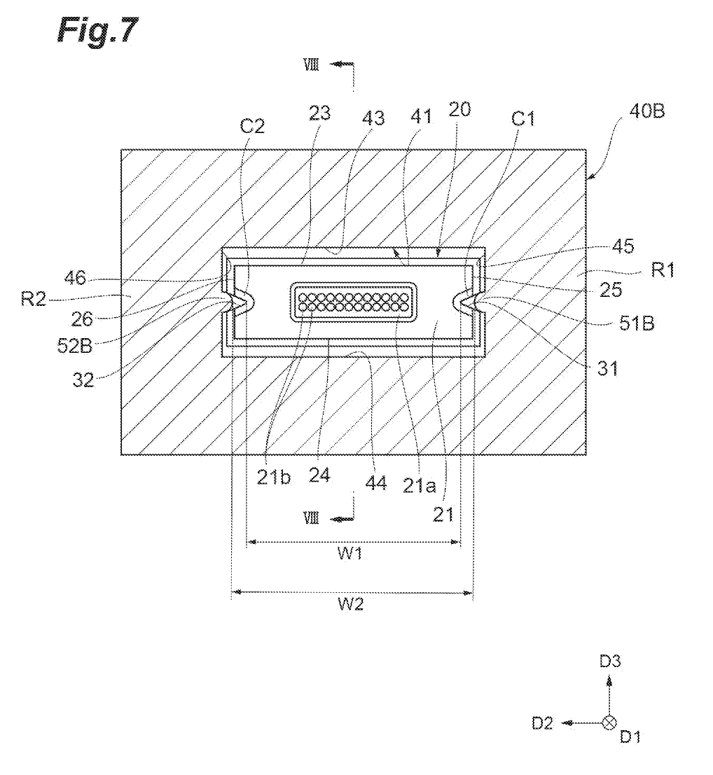

FIG. 7 is a cross-sectional view illustrating an adapter 40B in a state where the ferrule 20 is inserted and fitted in an optical connection structure according to a second modification example. In the example illustrated in FIG. 7, the adapter 40B is configured by a non-elastic material. In this case, examples of the material of the adapter 40B include polyphenylene sulfide (PPS). The pair of regions R1 and R2 of the adapter 40B are not provided with the hollow holes 61 and 62 in the embodiment described above. In other words, the entire regions R1 and R2 on both sides of the insertion hole 41 in the direction D2 are filled with the material of the adapter 40B. In this structure, elastic deformation of the adapter 40B is unlikely to occur even if a particularly hard material is not used as the material of the adapter 40B.

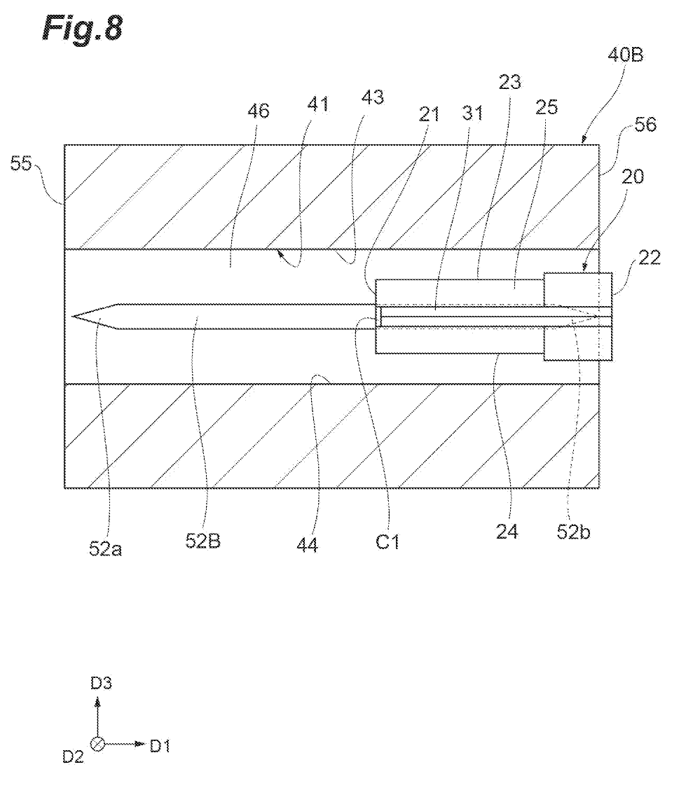

As illustrated in FIG. 7, the inner surfaces 45 and 46 of the adapter 40B are provided with a circular arc-shaped protrusion 51B and a circular arc-shaped protrusion 52B instead of the V-protrusions 51 and 52, respectively. The circular arc-shaped protrusions 51B and 52B are semicircular in a cross section perpendicular to the direction D1. The circular arc-shaped protrusion 51B extends along the direction D2 on the inner surface 45 of the adapter 40B. The circular arc-shaped protrusion 52B extends along the direction D2 on the inner surface 46 of the adapter 40B. FIG. 8 is a cross-sectional view of the adapter 40B along the VIII-VIII line of FIG. 7. In FIG. 8, the ferrule 20 is illustrated as a side view. As illustrated in FIG. 8, one end portion 52a of the circular arc-shaped protrusion 52B in the direction D2 is at a position slightly deviated to the other end surface 56 side from one end surface 55 of the adapter 40B in the direction D1. The other end portion 52b of the circular arc-shaped protrusion in the direction D2 is at a position slightly deviated from the other end surface 56 to the one end surface 55 side in the direction D1. The one end portion 52a is formed so as to taper toward the one end surface 55 side in the direction D1. The other end portion 52b is formed so as to taper toward the other end surface 56 side in the direction D1.

As illustrated in FIG. 7, the shortest distance W1 between the V-groove 31 and the V-groove 32 in the direction D2 is smaller than the shortest distance W2 between the circular arc-shaped protrusion 51B and the circular arc-shaped protrusion 52B in the direction D2. Accordingly, there is a gap between the circular arc-shaped protrusion 51B and the V-groove 31 in the direction D2 and there is a gap between the circular arc-shaped protrusion 52B and the V-groove 32 in the direction D2. When the ferrule 20 is inserted into the adapter 40B and fitted, the circular arc-shaped protrusion 51B enters the V-groove 31 of the ferrule 20 and abuts and the circular arc-shaped protrusion 52B enters the V-groove 32 of the ferrule 20 and abuts. At this time, the outer peripheral surface of the circular arc-shaped protrusion 51B abuts against the pair of surfaces configuring the V-groove 31, and the outer peripheral surface of the circular arc-shaped protrusion 52B abuts against each of the pair of surfaces configuring the V-groove 32. As a result, the ferrule 20 is held by the circular arc-shaped protrusions 51B and 52B of the adapter 40B and the positioning of the plurality of optical fibers 10 is performed.

Accordingly, the optical connection structure according to this modification example also has the same action and effect as the optical connection structure 1 according to the embodiment described above. In a case where the adapter 40B is configured by a material that is not elastically deformed, if the V-grooves 31 and 32 are configured to be respectively fitted to the V-protrusions 51 and 52 as in the embodiment described above, gaps are likely to be generated between the V-groove 31 and the V-protrusion 51 and between the V-groove 32 and the V-protrusion 52 due to, for example, the effect of a manufacturing tolerance. In this case, it is assumed that the position of the ferrule 20 with respect to the adapter 40 significantly deviates depending on the contact position between the V-groove 31 and the V-protrusion 51 or the contact position between the V-groove 32 and the V-protrusion 52. On the other hand, with a configuration in which the V-grooves 31 and 32 are respectively fitted to the circular arc-shaped protrusions 51B and 52B, it is possible to suppress a situation in which the position of the ferrule 20 with respect to the adapter 40B deviates depending on the contact positions between the V-grooves 31 and 32 and the circular arc-shaped protrusions 51B and 52B. As a result, a decline in the positioning accuracy of the optical fiber 10 can be suppressed.

The optical connection structure, the ferrule, and the optical connector of the present disclosure are not limited to the embodiment and modification examples described above, and various other forms are possible. For example, the embodiment and modification examples described above may be mutually combined depending on the required purpose and effect. In the embodiment and modification examples described above, the shapes of the ferrule and the adapter can be changed as appropriate. For example, the ferrule may be provided with three or more recess or protrusion portions although the ferrule is provided with two recess or protrusion portions in the embodiment and modification examples described above. In this case, the adapter may be provided with three or more protrusion or recess portions respectively fitted to the three or more recess or protrusion portions of the ferrule.

The shape of the recess or protrusion portion of the ferrule and the shape of the recess or protrusion portion of the adapter are not limited to the embodiment and modification examples described above and can be changed as appropriate. For example, each of the recess portions of the ferrule and the adapter may be a groove having another shape, such as a circular arc-shaped groove, a rectangular groove, and a trapezoidal groove, in addition to the V-groove. Likewise, the protrusion portions of the ferrule and the adapter may be protrusions different in shape, such as rectangular and trapezoidal protrusions, in addition to the V-protrusion and the circular arc-shaped protrusion.

The recess or protrusion portion may not extend along the direction D2 from the tip surface to the rear end surface of the ferrule. For example, the recess or protrusion portion of the ferrule may be separated from the tip surface to the rear end surface side in the direction D2 or may be separated from the rear end surface to the tip surface side in the direction D2. The recess or protrusion portion of the adapter may not extend along the direction D2 over the entire length of the adapter. For example, the recess or protrusion portion of the adapter may be separated from one end surface of the adapter in the direction D2 to the other end surface side or may be separated from the other end surface side in the direction D2 to the one end surface side.

The recess or protrusion portions may be provided on the side surfaces 23 and 24 facing each other along the direction D3 in the ferrules 20 and 20A, respectively. The position of the recess or protrusion portion of the side surface 25 and the position of the V-groove of the side surface 26 may be deviated from each other when viewed from the direction D2. The shape of the recess or protrusion portion of the side surface 25 and the shape of the recess or protrusion portion of the side surface 26 may be different from each other. For example, the side surface 25 may be provided with a V-groove with the side surface 26 provided with a circular arc-shaped groove. Alternatively, the side surface 25 may be provided with a V-groove with the side surface 26 provided with a V-protrusion.

The recess or protrusion portions may be provided on the inner surfaces 45 and 46 facing each other along the direction D3 in the adapters 40, 40A, and 40B, respectively. The position of the protrusion or recess portion of the inner surface 45 and the position of the protrusion or recess portion of the inner surface 46 may be deviated from each other when viewed from the direction D2. The shape of the protrusion or recess portion of the inner surface 45 and the shape of the protrusion or recess portion of the inner surface 46 may be different from each other. For example, the inner surface 45 may be provided with a V-groove with the inner surface 46 provided with a circular arc-shaped groove. Alternatively, the inner surface 45 may be provided with a V-groove with the inner surface 46 provided with a V-protrusion.

A plurality of lenses may not be formed on the tip surface of the ferrule. In this case, the ferrule may not be configured by a light transmitting resin. The ferrule may have a plurality of optical fiber grooves for respectively holding a plurality of optical fibers instead of the plurality of optical fiber holes for respectively holding the plurality of optical fibers. The adapter may not be configured by an elastic material in whole, and the adapter may be configured by an elastic material in part. For example, only the recess or protrusion portion of the adapter may be configured by an elastic material.

### Reference Signs List

1: optical connection structure, 2: optical connector, 5: optical fiber tape core wire, 10: optical fiber, 15: boot, 20, 20A: ferrule, 21: tip surface, 21a: light transmitting surface, 21b: lens, 21c: back surface, 22: rear end surface, 23, 24: side surface, 23a, 23b: opening, 25: side surface, 26: side surface, 31: V-groove, 31A: V-protrusion, 32: V-groove, 32A: V-protrusion, 40, 40A, 40B: adapter, 41: insertion hole, 43, 44, 45, 46: inner surface, 47, 48, 49, 50: outer surface, 51: V-protrusion, 51A: V-groove, 51B: circular arc-shaped protrusion, 52: V-protrusion, 52A: V-groove, 52a: one end portion, 52B: circular arc-shaped protrusion, 52b: the other end portion, 55: one end surface, 56: the other end surface, 61, 62: hollow hole, 71, 72: wall portion, C1: chamfered portion, C2: chamfered portion, D1: direction, D2: direction, D3: direction, H: optical fiber hole, L1: distance, P1, P2, P3, P4: part, R1, R2: region, W1, W2: shortest distance.

1. An optical connection structure comprising:
a plurality of optical fibers;
a ferrule holding the plurality of optical fibers; and
a tubular adapter where the ferrule is inserted and fitted such that the ferrule and another ferrule face each other in the tubular shape, wherein
the ferrule has a first side surface and a second side surface facing each other,
the first side surface is provided with a first recess portion or a first protrusion portion extending along a first direction in which the ferrule is inserted into the adapter,
the second side surface is provided with a second recess portion or a second protrusion portion extending along the first direction, and
an inner surface of the adapter is provided with a third protrusion portion or a third recess portion fittable with the first recess portion or the first protrusion portion and a fourth protrusion portion or a fourth recess portion fittable with the second recess portion or the second protrusion portion.

2. The optical connection structure according to claim 1, wherein
the ferrule further has a plurality of optical fiber holding portions respectively holding the plurality of optical fibers, and
the plurality of optical fiber holding portions are disposed side by side along a second direction intersecting the first direction.

3. The optical connection structure according to claim 1, wherein each of the first recess portion or the first protrusion portion and the second recess portion or the second protrusion portion is V-shaped in a cross section perpendicular to the first direction.

4. The optical connection structure according claim 1, wherein each of the third protrusion portion or the third recess portion and the fourth protrusion portion or the fourth recess portion is V-shaped in a cross section perpendicular to the first direction.

5. The optical connection structure according to claim 1, wherein each of the third protrusion portion or the third recess portion and the fourth protrusion portion or the fourth recess portion is semicircular in a cross section perpendicular to the first direction.

6. The optical connection structure according to claim 1, wherein
the first side surface is provided with the first recess portion,
the second side surface is provided with the second recess portion, and
the inner surface of the adapter is provided with the third protrusion portion fittable with the first recess portion and the fourth protrusion portion fittable with the second recess portion.

7. The optical connection structure according to claim 1, wherein the first recess portion or the first protrusion portion is capable of coming into contact with the third protrusion portion or the third recess portion and the second recess portion or the second protrusion portion is capable of coming into contact with the fourth protrusion portion or the fourth recess portion in a plane perpendicular to the first direction.

8. The optical connection structure according to claim 1, wherein at least one of the third protrusion portion or the third recess portion and the fourth protrusion portion or the fourth recess portion is configured to be elastically deformable in a second direction intersecting the first direction.

9. The optical connection structure according to claim 8, wherein
the adapter has a pair of regions positioned on both sides in the second direction with the third protrusion portion or the third recess portion and the fourth protrusion portion or the fourth recess portion interposed between the regions and respectively provided with the third protrusion portion or the third recess portion and the fourth protrusion portion or the fourth recess portion, and
a hollow portion is provided in the region as one of the pair of regions where the at least one is provided.

10. The optical connection structure according to claim 1, wherein
the ferrule has a tip surface positioned at a tip in the first direction and a rear end surface positioned at a rear end in the first direction,
the tip surface includes a light transmitting surface recessed to the rear end surface side in the first direction with respect to the tip surface, and
the light transmitting surface includes a plurality of lenses disposed so as to respectively overlap the plurality of optical fibers when viewed from the first direction.

11. A ferrule comprising:
a plurality of optical fiber holding portions for respectively holding a plurality of optical fibers; and
a first side surface and a second side surface facing each other, wherein
the first side surface is provided with a first recess portion or a first protrusion portion extending along a first direction in which the plurality of optical fiber holding portions extend, and
the second side surface is provided with a second recess portion or a second protrusion portion extending along the first direction.

12. The ferrule according to claim 11, wherein the plurality of optical fiber holding portions are disposed side by side along a second direction intersecting the first direction.

13. The ferrule according to claim 11, wherein each of the first recess portion or the first protrusion portion and the second recess portion or the second protrusion portion is V-shaped in a cross section perpendicular to the first direction.

14. An optical connector comprising:
the ferrule according to claim 11; and
the plurality of optical fibers respectively held in the plurality of optical fiber holding portions.
